(19) United States
(12) Patent Application Publication
(10) Pub. No.: US 2009/0104436 A1
(43) Pub. Date: Apr. 23, 2009

(54) Low-E Layered Systems Comprising Coloured Structures, Method for Producing the Latter and Use of Said Systems

(75) Inventors: Klaus-Jurgen Berg, Halle (DE); Frank Redmann, Halle (DE); Heinz Schicht, Bethau (DE)

Correspondence Address: K.F. ROSS P.C., 5683 RIVERDALE AVENUE, SUITE 203 BOX 900, BRONX, NY, 10471-0900, US

(73) Assignee: BORAGLAS GMBH, Halle/Saale (DE)

(21) Appl. No.: 11/921,536

(22) PCT Filed: Jun. 2, 2006
(86) PCT No.: PCT/EP2006/005314

§ 371 Date: Dec. 9, 2008

(30) Foreign Application Priority Data
Jun. 3, 2005 (DE) 10 2005 025 982.0

(51) Int. Cl. B32B 5/16; C03C 17/36; B01J 19/12

(52) U.S. Cl. 428/328; 204/157.41

(57) ABSTRACT

The invention relates to low-B layered systems containing at least one metal layer consisting of gold, silver or copper, which is embedded between layers of transparent metal oxides. According to the invention, the layered system is modified in the vicinity of the endured structures to form a material configuration, in which the gold, silver and copper are present in the form of nanoparticles embedded in a matrix, which is formed from the substances of the layered system that were originally present in layers.

The invention relates to low-E layered systems comprising COLORED structures and a method for producing the structures and use of the systems.

Low-E-layers and low-E layered systems have high reflection and low emissivity (low-E: low emissivity) associated therewith during high transmission in the visible part of the spectrum in the infrared spectral range. Consequently, they act as good reflectors for heat radiation at room temperature and lend glass and transparent polymer foils a very good heat insulation which they would not have without such a coating. A typical representative of the homogeneous low-E-layers is a layer consisting of In₂O₃:Sn (ITO) and, for the low-E layered systems, a system of layers in which a layer of silver is embedded as a functional layer. Instead of the silver layer, gold or copper layers are also used in the layered systems for producing the high reflection in the infrared spectral range. There are also layered systems which are not uniformly designated as a low-E system in spite of a very high reflection in the infrared spectral range. They are more or less strongly COLORED and are not primarily used for heat insulation, but for protection against the sun. For example, the firm Southwall Europe applies strongly COLORED layered systems of this type, which contain two or even three layers of silver in the system, to polyethylene terephthalate (PET) foils and then describes them as solar-control foil products.

All of the above-described systems belong to layered systems which are characterized thereby that they contain at least one metal layer of gold, silver or copper which are embedded between layers of transparent metal oxides and which will be designated collectively as low-E layered systems in the following due to the high reflection produced by the metal layers and the low emissivity in the infrared spectral range associated therewith.

Layered systems dominate in the architectural field. In most cases, a silver layer which is only about 10 nm thick forms the functional basis, and, to obtain the transparency of the glass in the visible spectral range, the silver is dereflected by embedding in highly refractive oxides for these wavelengths. Tin dioxide, but also tin oxide, bismuth(III) oxide or indium(III) oxide are generally used for this. In addition, so-called blocker layers are required which prevent a corrosion of the silver layer, and top layers almost always seal the layered system toward the outside to increase the scratch resistance.

The layered system is produced by magnetron sputtering in a vacuum, whereby float glass formats in production widths of 3.21 m and 6 m length are coated on the so-called fire or atmospheric side. The resultant low-E glass is further processed to form double or triple insulating glass of various sizes or also to form compound safety glass (VSG). The coated glass side is thereby protected from the outside air inside the hermetically sealed glass pane interstices of the insulating glass or inside the glass compound directly in the contact surface to a transparent adhesive layer (usually a thermoplastic polyvinyl butyral (PVB) foil).

In another variant of insulating glass, a foil which is also similarly coated by means of magnetron sputtering is fixed in the hermetically sealed pane interstice between two uncoated glass panes. The direct installation of coated foils of this type, which are additionally laminated between PVB foils and provided with a special adhesive, to existing windows and facades is also practiced.

Identification means which are already used in many other production processes are also required for production and further processing of the low-E glasses and foils, On the one hand, it facilitates the organization of the production cycle and, on the other hand, enables product tracking. Due to the continuous change in contents of the identification, only laser-assisted identification methods, which are computer controlled, are suitable, as these are much more flexible than, for example, printed marks or the like.

One possibility would be to apply known laser-assisted identification processes to the support means for the-low-E layers, i.e. glass or foil. However, in this case, the disadvantages of the respective known processes must be taken into consideration.

Known processes (DE 41 26 626 C2, DE 44 07 547 C2, DE 198 55 623 C1) for identifying glass use, for example, the production of microcracks inside the glass by using non-linear processes in the focus range of laser radiation for which the glass is transparent. The microcracks scatter and absorb light from the visible spectral range and are consequently visible. Due to the local crack formation, these processes weaken the mechanical stability and are thus disadvantageous, in particular in very thin glasses.

The disadvantage of mechanical damages is also associated with the method for marking or decorating surfaces of transparent substrates, in particular substrates of glass (EP 0 531 584 A1). In this method, an auxiliary layer which absorbs laser radiation with wavelengths of between 0.3 and 1.6 μm is applied to the surface in which a heated plasma is produced during the laser radiation which has a processing effect on the substrate. This indirect interaction of the laser beam with the transparent substrate produces grooves in the surface which produce an appearance of the radiated areas that is similar to that of sandblasting or chemical matting.

No mechanical damages occur in the method of colored interior coating (see /1/ and /2/) in which nanoparticles of gold, silver or copper are produced inside the glass due to locally limited heating of the glass due to absorption of laser radiation. They color the glass red (gold and copper) and, in the case of silver, yellow. The disadvantage of this method is that it can only be used in glass in which the gold, silver or copper ions were already incorporated during melting (DE 198 41 547 B4) or in which, in an additional step prior to the laser-radiation, Na ions of the glass surface were replaced by silver or copper ions of a fused salt in contact with the glass surface by means of an ion exchange. In both cases, moreover, the glass must contain ions which reduce the ionic gold, silver or copper to atoms in a thermal action, before they separate as nanoparticles due to their low solubility in the glass.

DE 101 19 302 A1 and WO 02/083589 A1 describe how the additional step can be avoided prior to the action of the laser radiation in that the part of the glass surface to be inscripted is in contact with a donor medium for silver or copper ions during the action of the laser radiation. The processes required to produce the metallic nanoparticles causing the glass coloring, i.e. the ionic exchange and diffusion of silver or copper ions in the glass whose reduction to atoms and the aggregation into nanoparticles, then all occur more or less simultaneously during the action of the laser radiation.

With reference to DE 101 19 302 A1, DE 102 50 408 A1 then proposes coatings as donor media for silver ions, and their compositions are noted as well as methods for producing the coating compositions and for coating. The described compositions contain at least one silver compound which is soluble in an aqueous and/or organic solvent and at least one binding agent. This application of the layer and the required rinsing after completion of the laser radiation remain a disadvantage.

Auxiliary layers, which must again be removed after the laser radiation, are also required for a method for the surface structuring of any materials desired (DD 221 401 A1) and a method for producing visually observable markings on transparent materials (U.S. 64 42 974 B1). In both cases, the structure or the marking on the surfaces is formed by transmitting material from the auxiliary layers. This occurs by using laser radiation which produces a heating, melting and evaporation of the material in the radiated areas of the auxiliary layers. The main field of application of DD 221 401 A1 is in producing conductor paths for microelectronics and also for marking windshields consisting of multilayer safety glass used in traffic systems according to U.S. 64 42 974 B1.

DE 101 62 111 A1 describes a method in which, aside from the laser radiation, no further steps are required to affix a permanent marking in a transparent component. In this case, the marking is spaced from the surface and consists of only one zone in the mechanically undamaged material having a complex refractive index different from the initial state which is visible and can be proven by optical methods. The changes in the complex refractive index are thereby produced by non-linear optical effects of the excitation at high energy density in the focus of a laser beam which consists of ultra-short pulses having a pulse duration of less than 10⁻¹⁰ s. In addition, e.g. a TI:sapphire laser is used, the high cost of which is disadvantageous.

It is also known to structure low-E layered systems with aid of laser beams, i.e. to introduce point-like or linear, optionally even flat, interruptions into the continuously isolated layer. For example, this serves to separate conductor path sections by dividing lines (electrical insulation when using the layered systems as electric resistance heating), to produce local windows for the otherwise reflected rays (“communication windows”), or simply for removing the coating, e.g. along the edge of a support material pane if an adhesive strip with good adhesion is to be affixed there. These structurings are colorless and are based thereon that the layer can be completely removed locally.

The object of the invention is to develop a method for the colored structuring which is not attached to the support material, i.e. glass or polymer foil, but directly to the low-E layered system, requires no further procedural steps except the 5 action of suitable laser radiation, and does not depend on costly lasers to produce ultra-short pulses of less than 10⁻⁰ s duration, and, with this method, to introduce color-structured low-E layered systems as a new product.

This object is solved according to claim 1 by a low-E layered system comprising colored structures in which the layered system is changed in the area of the colored structures to form a matrix with nanoparticles consisting of gold, silver or copper, which is formed from the substances of the layered system originally present in layers, and by a method for producing the colored structures according to claim 7.

In the method, laser radiation having a wavelength from the dereflected spectral range of the low-E layered system is directed to the low-E layered system and heated by it through its absorption in the metal layer to such an extent that there is a drastic change in the layered system in the radiated area. As a result of the change, the gold, silver or copper is present in the form of nanoparticles, embedded in a matrix, formed from the substances of the layered system which were originally present in layers. This material configuration is associated with a coloring. The color varies in transparency between light yellow and dark brown in the case of silver and various shades of red (gold, copper), namely depending on the particle size, concentration and distribution produced and refractive index of the resultant matrix, which can all be controlled by the radiation conditions. When the radiated areas are observed diagonally, the reflection effect dominates and they then have the appearance of vapor-treated metal layers.

In a preferred embodiment, a beam with Gaussian intensity distribution of a pulsed Nd:YAG laser is focused on the low-E layered system. A colored circular surface (pixel) having a diameter of less than 10 μm to 100 μm (depending on the degree of focusing) is already produced by a single pulse of 2·10⁻⁷ s in duration and an energy of 0.4 mJ.

As was profilometrically determined, the pixel represents an indentation in the layered system which is surrounded by a wall. In the microscope, the wall can be seen as a colored, annular limit of a differently colored circular surface. The dimensions of the indentation and the height of the wall again depend on the concrete radiation conditions and the concrete structure of the layered system. Typical values are 60 nm (indentation) or 20 nm (wall).

They can be changed to the same surface by action of further pulses, whereby saturation values can be attained relatively quickly at pulse repetition frequencies of between 300 Hz and 3000 Hz.

The colored pixels can be combined to form any markings, inscriptions, decorative structures and half-tone images desired by a relative movement between laser beam and layered system, whereby the structures per se can also be colored or have continuous color patterns.

If surfaces are composed of individual pixels having a macroscopically uniform appearance, then the appearance can be varied by different mutual arrangement of the pixels. The color impression which is made by a surface built up of non-overlapping pixels is different from that formed by one of overlapping pixels.

Surfaces having a macroscopically uniform appearance can be similarly built up from lines having a more or less strong degree of overlapping and then different appearance, for which lines which are already macroscopically very different in color and form can be used.

The microscopic appearance of the lines is effected by the degree of the pixel overlapping, i.e. from the relative speed between low-E layered system and laser beam as well as the pulse repetition frequency and quite essentially by the intensity of the laser beam.

With intensities which are at the lower end of the usable intensity ranges, lines which are increased by about 20 μm vis- vis the surface and have a rectangular cross section are produced and, in the case of silver-based layered systems, with a dark brown color. With intensities which are closer to the upper end of the effective intensity range, which is determined by the slightest intensity from which damages of the support material occur, the middle parts of the lines are lowered and may also lie lower than the surface of the non-radiated layered system. That is, the lines are then parallel to their longitudinal extension and limited by walls. In the microscope, these walls can be seen as darker limits of a lighter line. Macroscopic surfaces composed of such lines show, in transparency, yellow to light-yellow colorings on silver-based layered systems.

The colored structures produced by laser radiation are mechanically at least as stable as the untreated low-E layered system and chemically resistant to water, conventional household chemicals and solvents. They are insensitive to UV radiation, even at very long durations of action. The thermal stability is limited by that of the PET foil, if the low-E layered system is based on it. They resist temperatures of up to 550° C. on float glass. Then a change in colors takes place without the forms of the structures changing.

The colored areas no longer have any low-E properties, the high reflection in the close-range infrared spectral range is broken down and a distinct reflection band exists in the visible spectral range. Moreover, the relatively good surface conductivity has been lost and corresponds to that of conventional plate glass.

### EXAMPLES OF EMBODIMENTS

### Example 1

A low-E layered system, which is found on the atmospheric side of a 4 mm thick floating glass pane, is used as starting material. The materials noted in the following follow one another in the layered system, starting from the glass surface, having the layer thicknesses noted in brackets, measured in nm: SnO₂ (30), ZnO (2), Ag (13), TiO₂ (2.6), SnO₂ (40).

Laser radiation, having the wavelength 1064 nm, of a quality Nd:YAG laser was focused on the layered system, for which the original beam with a diameter of 1 mm and a Gaussian intensity profile successively passed through a 1:4 beam expander and a convex lens having a focal length of 30 mm. In this way, locations which were clearly separate from one another were exposed to a single pulse with a duration of 200 ns and an energy which was varied between 0.3 mJ and 12 mJ.

As a result, pixels having a diameter of about 100 μm were produced.

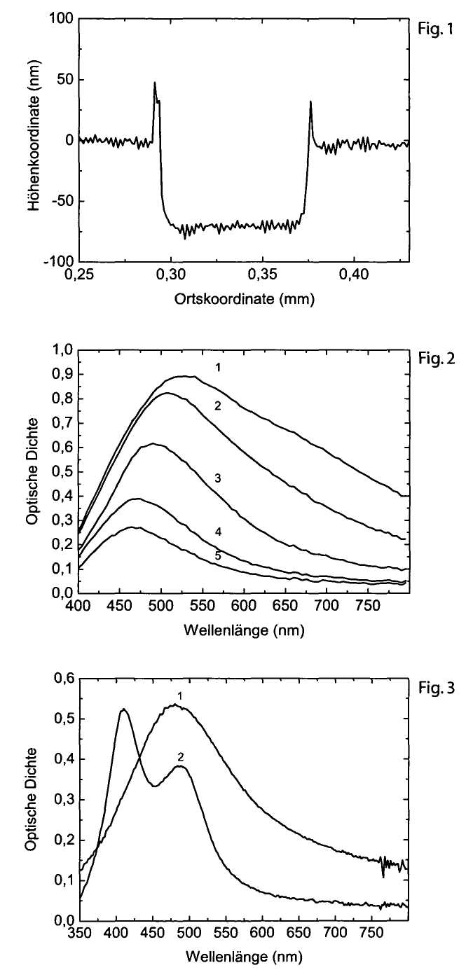

FIG. 1 shows the height profile of the pixel produced with a pulse of the energy 0.3 mJ along a straight line through the center of the pixel on which the zero point of the location coordinates is arbitrarily outside of the range shown and the zero point of the height coordinates characterizes the position of the surface of the untreated layered system. The formation of a wall surrounding the pixel and the crater-like indentation in the center can be clearly seen.

FIG. 2 shows the optical density, measured in the central area of the pixel with a microscope spectral photometer as a is function of the wavelength, whereby the consecutive numbering of the curves corresponds to increasing energy of the individual pulses.

### Example 2

A colored pixel was produced on a low-E pane of the type described in Example 1, as described there, by an individual pulse. The pane was then exposed to a temperature treatment of one hour duration at 600° C. This resulted in a change in color of the pixel.

FIG. 3 documents the change in color by the optical density measured in the center of the pixel with a microscope spectral photometer as a function of the wavelength before (curve 1) and after (curve 2) the heat treatment.

### Example 3

Colored surfaces consisting of non-overlapping parallel lines were produced on the low-E layered system described in Example 1 with the laser which was also described in the example. The lines were produced with a stationary laser by a movement of the layered system in the focus plane at a speed of 2 mm/s with a pulse repetitive frequency of 1 kHz. Contrary to Example 1, a lens with a focal length of 70 mm was now used for focusing the laser radiation.

FIG. 4 shows a selection of the optical density measured on various surfaces as a function of the wavelength, whereby the consecutive numbering of the curves corresponds to increasing energy of the pulses, which were varied between 0.3 mJ and 12 mJ. The broken curve a was measured on the untreated layered system.

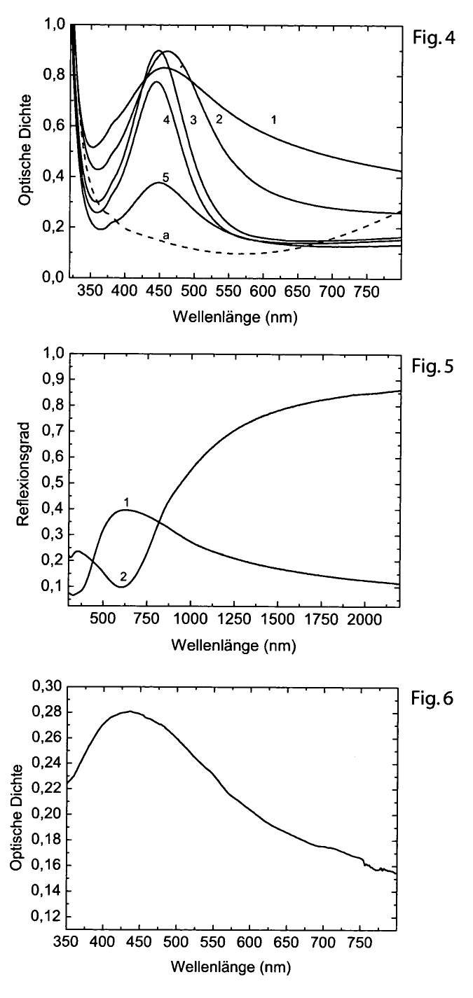

FIG. 5 shows the wavelength dependency of the degree of reflection of one of the colored surfaces (curve 1) together with that of the untreated layered system (curve 2). The measuring took place with a light impacting the coated side of the glass at less than 6° C., i.e. at an almost perpendicular incidence.

### Example 4

The starting material for this embodiment is a commercial low-E plastic foil (PET) of the type Heat Mirror3 HM 55 of the firm Southwall Europe GmbH, in which the functional silver layer is embedded in the visible spectral range in indium(III) oxide for the reflection. A ten-FIG. number with 600 dpi resolution was applied to it within 12 s with a commercial laser inscription system StarMark® SMC 65 (the firm Rofin, Baasel Lasertech) with a lamp-pumped Nd:YAG laser of 65 W rated output as beam source. The individual numbers have a size of 5.2 mm and a line width of 0.6 mm.

FIG. 6 shows the optical density measured on a number with a microscope spectral photometer as a function of the wavelength.

### BIBLIOGRAPHY

/1/ T. Rainer, K.-J. Berg, G. Berg. “Farbige Innenbeschrift von Floatglas durch CO₂-Laserbestrahlung”, Brief Report of the 73rd Glass Technology Convention, Halle (Saale) 1999, Deutsche Glastechnische Gesellschaft (DGG), pp. 127-130.
/2/ T. Rainer. “Wird Fensterglas zum High-Tech-Material? Kleine Teilchen, Grosse Wirkung”, Glauwelt 6/2000, pp. 46-51.

1. Low-E layered systems comprising colored structures, containing at least one metal layer consisting of gold, silver or copper, which is embedded between layers of transparent metal oxides wherein the layered system is modified in the vicinity of the colored structures to form a material configuration in which the gold, silver and copper are present in the form of nanoparticles embedded in a matrix, which is formed from the substances of the layered system that were originally present in layers.

2. The low-E layered systems according to claim 1, wherein the structures consist of overlapping or non-overlapping pixels.

3. The low-E layered systems according to claim 1 wherein the layered systems are situated on a support material.

4. The low-E layered systems according to claim 1 wherein the support material is float glass.

5. The low-E layered systems according to claim 1 wherein the support material is a plastic foil polyethylene terephthalate (PET).

6. The low-E layered systems according to claim 1 wherein the layered systems are situated on PET foils as support material and, in addition, are arranged on or between polyvinyl butyral (PVB) foils.

7. A method for the colored structuring of low-E layered systems containing at least one metal layer consisting of gold, silver or copper embedded between layers of transparent metal oxides, the method comprising the step of:
directing laser radiation is directed on the low-E layered system with a wavelength from the reflected spectral range of the layered system, as a result of which the layered system is modified in the radiated range to form a matrix containing nanoparticles consisting of gold, silver or copper, which is formed from the substances originally present in the layers.

8. The method according to claim 7, wherein the radiation of a ND:YAG laser is used.

9. The method according to claim 7 wherein a laser beam with a Gaussian intensity profile is used.

10. The method according to claim 7 wherein a laser beam consisting of pulses with a duration of >10⁻¹⁰ s is used.

11. The method according to claim 7 wherein a focused laser beam is used.

12. The method according to claim 7 wherein the colored structure is produced by a relative movement between laser beam and low-E layered system.

13. The method according to claim 7 wherein the colored structure is produced from pixels.

14. The method according to claim 7 wherein colored lines are produced from overlapping pixels by a suitable combination of pulse repetition frequency and relative speed.

15. The method according to claim 7 wherein colored surfaces are produced from parallel lines with a more or less strong degree of overlapping.

16. The method according to claim 7 wherein various structures with respect to coloring and form are produced by varying the conditions relative speed, pulse repetition frequencies and pulse energy as well as focusing of the laser radiation.

17. The method according to claim 7 wherein a thermal treatment of the low-E layered system is carried out for the change in color after the laser radiation.

18. The method according to claim 7 wherein the layered system is applied to a support material.

19. The method according to claim 7 wherein glass or plastic foils of PET are used as support materials.

20. Use of low-E layered systems with colored structures according to claim 1 as storage medium.

21. Use of low-E layered systems with colored structures according to claim 1 for decorative purposes.
